(19) United States
(12) Patent Application Publication
(10) Pub. No.: US 2019/0065586 A1
(43) Pub. Date: Feb. 28, 2019

(54) LEARNING METHOD, METHOD OF USING RESULT OF LEARNING, GENERATING METHOD, COMPUTER-READABLE RECORDING MEDIUM AND LEARNING DEVICE

(71) Applicant: FUJITSU LIMITED, Kawasaki-shi (JP)

(72) Inventor: Hiyori Yoshikawa, Kawasaki (JP)

(73) Assignee: FUJITSU LIMITED, Kawasaki-shi (JP)

(21) Appl. No.: 16/117,043

(22) Filed: Aug. 30, 2018

(30) Foreign Application Priority Data
Aug. 31, 2017 (JP) 2017-167707

(51) Int. Cl. G06F 17/30; G06N 3/08; G06F 17/27; G06F 15/18

(52) U.S. Cl. CPC G06F 17/30705; G06F 15/18; G06F 17/278; G06N 3/08

(57) ABSTRACT

A learning device generates an input vector obtained by loading a distributed representation of each of words or phrases included in subject data into a common dimension and a dimension corresponding to a data class representing a role in the subject data. The learning device executes machine learning that uses the input vectors and that relates to features of the words or phrases included in the subject data.

### CROSS-REFERENCE TO RELATED APPLICATION

This application is based upon and claims the benefit of priority of the prior Japanese Patent Application No. 2017-167707, filed on Aug. 31, 2017, the entire contents of which are incorporated herein by reference.

### FIELD

The embodiments discussed herein are related to a learning method, a method of using a result of learning, a learned model, a data structure, a generating method, a computer-readable recording medium and a learning device.

### BACKGROUND

In prediction and classification by a general neural network, a sequential value vector is used as an input and an output vector is acquired through linear transformation or non-linear transformation on single to multiple layers and then a discriminative model and a regression model are applied to the output vector to perform prediction and classification.

For example, when discrete data that is not in a form of a set of sequential values or a series, such as a natural language or a history of purchase of goods, is applied to a neural network, the input is transformed into a sequential value vector representation. In general, known transformation parameters are used to transform the respective words in discrete data into distributed representations that are fixed-length vectors and the distributed representations are input to the neural network. Parameters that are weights on inputs to respective layers in linear transformation or non-linear transformation are adjusted to obtain a desirable output so that learning by the neural network is executed.

There is an increase of tasks to deal with a relationship between partial structures in input data, such as a relationship classification task to estimate a relationship between two entities (a name of person and a name of place) that are written in a natural language, as a subject of machine learning using a neural network. A relationship classifying task will be taken as an example. For classification, in addition to the natural sentence, information about which two entities in the sentence are noted need be taken into consideration. In other words, “the segments corresponding to the entities to note” and “segments other than the entities to note” in the input sentence need be dealt with distinctively. There is a method of, when such information is dealt with, assigning, to each word in the input sentence, an attribute representing to which of “a segment corresponding to an entity to note” and “a segment other than entities to note” the word corresponds. A task-dependent attribute that is assigned to such data is referred to as “data class” below. In a case of learning that deals with data classes, data classes are determined only after a task is set and thus it is difficult to perform pre-learning, such as acquiring distributed representations for which discrimination between data classes is taken into consideration from data other than learning data for the task and there occurs a need to acquire characteristics for which data classes are taken into consideration only from a relatively small amount of labeled learning data. This results in less progressive learning of the amount of characteristics that is a combination of a data class and characteristics (features) other than the data class contained in the input data and, as a result, performance of prediction and classification using the learned model deteriorates.

As a technology to deal with data classes in machine learning, there is a known method in which information that identifies a data class is regarded as a word, the data class of the word is represented by a positional relationship of the data class with a subject word, and series data is analyzed by using a recurrent neural network (RNN), or the like. For example, a word corresponding to an entity to be learned is marked by a position indicator and discriminated, input data containing the PI is transformed into a distributed representation by a common transformation parameter not dependent on data classes and the distributed representation is input to the neural network to perform learning.

Patent Document 1: Japanese Laid-open Patent Publication No. 2015-169951

In the above-described technology, however, as the data class is represented by the positional relationship with the subject word, identifying the series data is needed to identify the data class and thus a large number of resources are needed for both learning and determination.

Note that a method of dealing with data classes that are task-dependent attributes as features of data may be assumed. In this method, for features about acquisition of a distributed representation corresponding to each feature, pre-learning using a method not taking data classes into consideration may be possible. On the other hand, features corresponding to data classes are learned from only learning data. This results in less progressive learning and, particularly, when the amount of learning data is small, accuracy of determination and classification using a result of learning is poor.

### SUMMARY

According to an aspect of an embodiment, a learning method includes generating an input vector obtained by loading a distributed representation of each of words or phrases included in subject data into a common dimension and a dimension corresponding to a data class representing a role in the subject data, using a processor; and executing machine learning that uses the input vectors and that relates to features of the words or phrases included in the subject data, using the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an entire configuration from a learning process to a determination process according to a first embodiment;

FIG. 2 is a functional block diagram illustrating a functional configuration of a learning device according to the first embodiment;

FIG. 3 is a table representing exemplary information that is stored in a learning data DB;

FIG. 4 is a table representing exemplary information that is stored in teaching data DB;

FIG. 5 is a diagram illustrating exemplary generation of an input vector corresponding to Entity 1;

FIG. 6 is a diagram illustrating exemplary generation of input vector corresponding to another entity;

FIG. 7 is a diagram illustrating exemplary generation of an input vector corresponding to Entity 2;

FIG. 8 is a diagram illustrating exemplary learning;

FIG. 9 is a flowchart illustrating a flow of processes;

FIG. 10 is a diagram illustrating an effect of learning using a distributed representation of each data class;

FIG. 11 is a diagram illustrating an effect of learning by distributed representations of common features not dependent on data classes;

FIG. 12 is a diagram illustrating an effect of learning according to the first embodiment; and

FIG. 13 is a diagram illustrating an exemplary hardware configuration.

### DESCRIPTION OF EMBODIMENTS

Preferred embodiments will be explained with reference to accompanying drawings. Note that the embodiments do not limit the invention. The embodiments may be combined as appropriate as long as no inconsistency is caused.

Entire Configuration

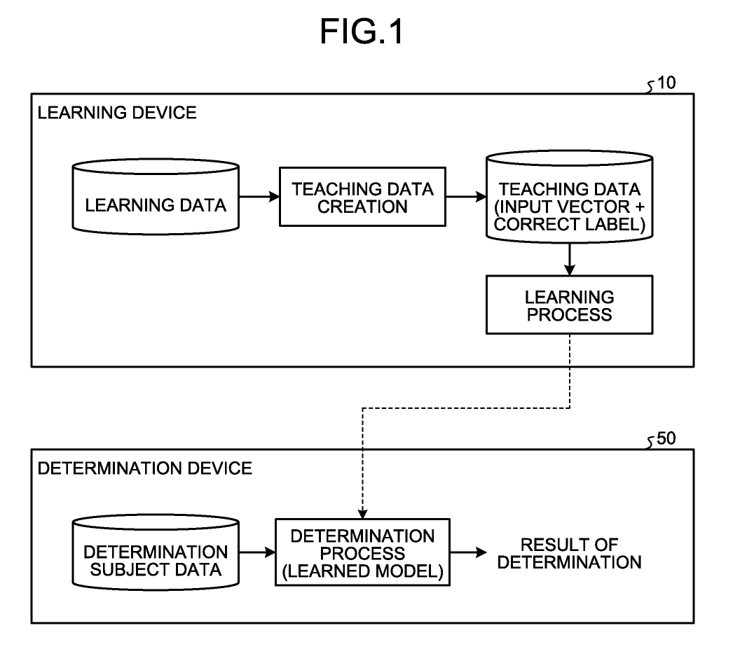

FIG. 1 is a diagram illustrating an entire configuration from a learning process to a determination process according to a first embodiment. As illustrated in FIG. 1, in the first embodiment, an example where a learning device 10 that performs the learning process and a determination device 50 that performs the determination process execute the processes in different chassis; however, the processes are not limited thereto. The processes may be executed in the same chassis. Each of the learning device 10 and the determination device 50 is an exemplary computer device, such as a server, a personal computer or a tablet.

The learning device 10 executes learning that deals with data classes that are dependent on a task of classification about which relationship there is between entities in input data. Specifically, the learning device 10 executes a process of creating teaching data from learning data in a form of a series, such as a sentence that is extracted from a newspaper article or a website. The learning device 10 then executes a learning process using the teaching data that is generated from the learning data to generate a learned model.

For example, the learning device 10 generates, for each set of learning data, an input vector obtained by loading a distributed representation of each word or phrase contained in the learning data into a common dimension and a dimension corresponding to a data class representing a role in the learning data. From each set of learning data, the learning device 10 generates teaching data in which an input vector and a correct label are associated with each other. The learning device 10 then inputs the teaching data to a neural network, such as an RNN to learn a relationship between the input vector and the correct label and generate a learned model.

As described above, the learning device 10 is able to execute learning of a relationship classification model to accurately classify a relationship between specified entities and thus enables efficient learning using less learning data.

The determination device 50 inputs determination subject data to the learned model reflecting the result of learning by the learning device 10 and acquires a result of determination. For example, the determination device 50 inputs, to the learned model in which various parameters of the RNN obtained through the learning by the learning device 10, an input vector obtained by loading a distributed representation of each word or phrase contained in the determination subject data into a common dimension and a dimension corresponding to a data class representing a role in the determination subject data. The determination device 50 then acquires a value representing a relationship between specified data classes according to the learned model. In this manner, the determination device 50 is able to obtain a determination result by inputting determination subject data. The method of generating an input vector from determination subject data is similar to the method of generating an input vector from learning data.

Functional Configuration

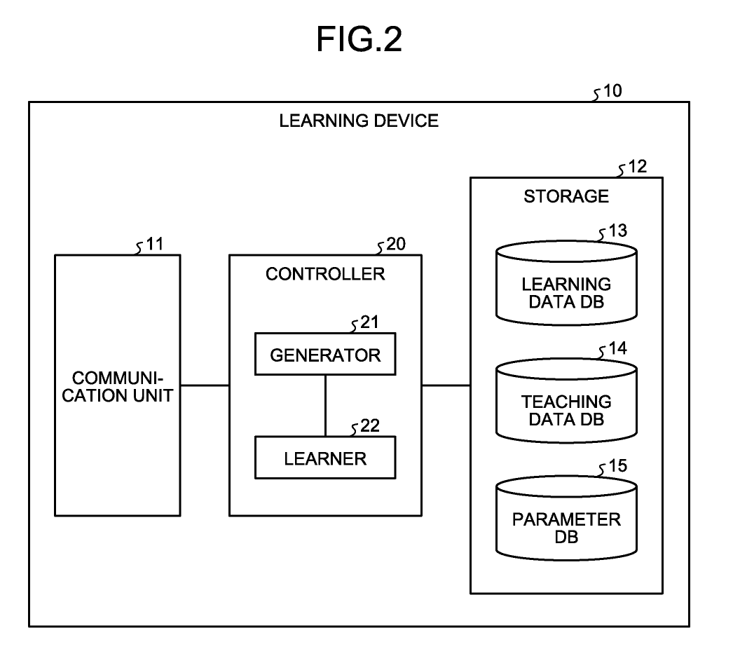

FIG. 2 is a functional block diagram illustrating a functional configuration of the learning device 10 according to the first embodiment. The determination device 50 has the same function as that of a general determination device except for that the learned model reflecting the result of learning by the learning device 10 is used, and thus detailed descriptions thereof will be omitted.

As illustrated in FIG. 2, the learning device 10 includes a communication unit 11, a storage 12 and a controller 20. The communication unit 11 is a processing unit that controls communication with other devices and inputs and outputs to and from other devices and is, for example, a communication interface or an input/output interface. For example, the communication unit 11 receives an input, such as learning data, and outputs a result of learning to the determination device 50.

The storage 12 is an exemplary storage device that stores programs and data and is, for example, a memory or a processor. The storage 12 stores a learning data DB 13, a teaching data DB 14 and a parameter DB 15.

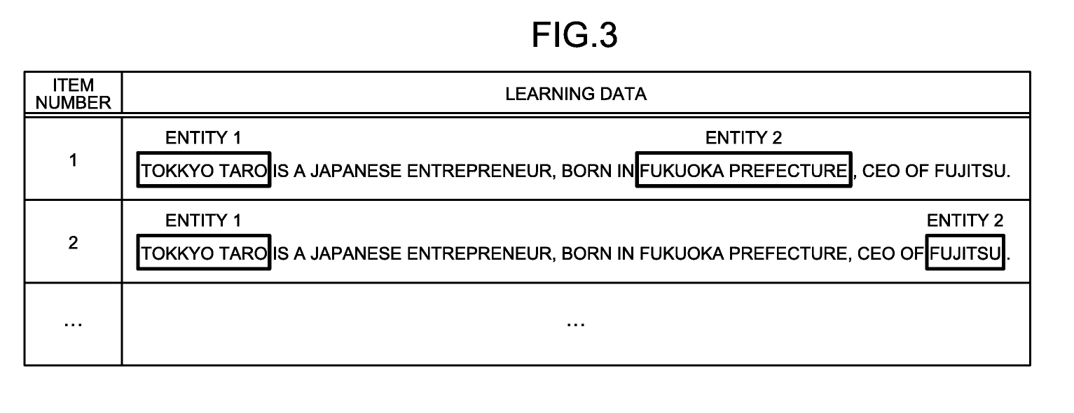

The learning data DB 13 is a database that stores learning data from which teaching data originates. The information stored in the learning data DB 13 is stored by a manager, or the like. FIG. 3 is a table representing exemplary information that is stored in the learning data DB 13. As illustrated in FIG. 3, the learning data DB 13 stores “item numbers and learning data” in association with each other. An “item number” is an identifier that identifies learning data and “learning data” is itself data to be learned.

In the example in FIG. 3, the learning data of Item 1 is “Tokkyo Taro is a Japanese entrepreneur, born in Fukuoka Prefecture, CEO of Fujitsu” and represents that “Tokkyo Taro” is specified as Entity 1 and “Fukuoka Prefecture” is set as Entity 2. Similarly, the learning data of Item 2 is “Tokkyo Taro is a Japanese entrepreneur, born in Fukuoka Prefecture, CEO of Fujitsu” and represents that “Tokkyo Taro” is specified as Entity 1 and “Fujitsu” is set as Entity 2.

An entity herein is one type of data class representing a role in the subject data and represents a subject whose relationship is to be learned in the learning data, which is the input data, and the manager, or the like, can specify entities optionally. Specifically, the case of Item 1 represents that the relationship between Tokkyo Taro and Fukuoka Prefecture is to be learned among the words in the sentence that is the learning data, and the case of Item 2 represents that the relationship between Tokkyo Taro and Fujitsu is to be learned among the words in the sentence that is the learning data. The example where there are two entities will be described. Alternatively, one or more entities may be used.

The learning data is obtained by sequentially storing time-series data that occurred over time. For example, the learning data of Item 1 occurs sequentially from “Tokkyo” and “.” is the data that occurs last and the learning data is data obtained by connecting and storing sets of data according to the order of occurrence of the sets of data. In other words, the learning data of Item 1 is data where “Tokkyo” appears first and “Tokkyo” appears last. A range of one set of learning data may be changed and set optionally.

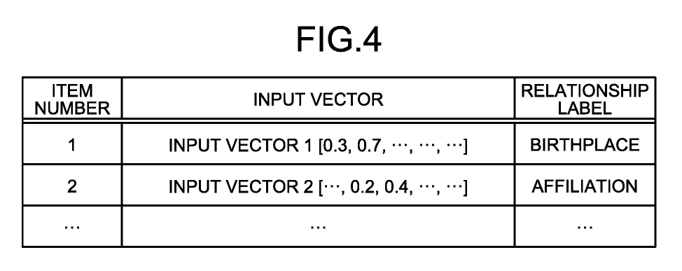

The teaching data DB 14 is a database that stores teaching data that is used for learning. Information that is stored in the teaching data DB 14 is generated by a generator 21, which will be described below. FIG. 4 is a diagram illustrating exemplary information that is stored in the teaching data DB 14. As illustrated in FIG. 4, the teaching data DB 14 stores “item numbers, input vectors and relationship labels” in association with one another.

An “Item number” is an identifiers that identifies teaching data. An “input vector” is input data to be input to the neural network. A “relationship label” is a correct label representing a relationship between entities.

In the example in FIG. 4, teaching data of Item 1 represents that the input vector is “Input vector 1 [0.3, 0.7, . . . , . . . , . . . ]” and the relationship label is “birthplace”. The item numbers in FIG. 4 and the item numbers in FIG. 3 are synchronized and it is represented that the teaching data that is generated from the learning data of Item 1 in FIG. 3 corresponds to Item 1 in FIG. 4. Thus, it is represented that learning is performed using the input vector of Item 1 in FIG. 4 such that the relationship between Entity 1 “Tokkyo Taro” and Entity 2 “Fukuoka Prefecture” is “birthplace” in the learning data of Item 1 in FIG. 3.

The parameter DB 15 is a database that stores various parameters that are set in the neural network, such as a RNN. For example, the parameter DB 15 stores weights to synapses in the learned neural network, etc. The neural network in which each of the parameters stored in the parameter DB 15 is set serves as the learned model.

The controller 20 is a processing unit that controls the entire learning device 10 and is, for example, a processor. The controller 20 includes the generator 21 and a learner 22. The generator 21 and the learner 22 are exemplary electronic circuits of the processor or exemplary processes that are executed by the processor.

The generator 21 is a processing unit that generates teaching data from the learning data. Specifically, the generator 21 generates an input vector obtained by loading a distributed representation of each word or phrase contained in the learning data into a common dimension and a dimension corresponding to a data class representing a role in the learning data. A data class represents a role in the learning data and is a task-dependent attribute that is needed to clarify a task to be solved from among attributes of input data in a determination task or a classification (learning) task. A task represents a learning process and represents a process of classification on which relationship is between entities in the input data.

Each of words of which learning data consists is represented by a combination of various features of not only a surface layer of a word, such as “Tanaka” or “Tokkyo”, but also a word class, such as “noun” or “particle”, and a unique representation representing “a person or an animal represented by word”, or the like. In order to represent this as an input to the neural network, the generator transforms the respective features to sets of discrete data using known transformation parameters corresponding to the respective features and combines the sets of discrete data of the respective each features, thereby generating a distributed representation of each word. The generator 21 generates an input vector (distributed representation) from each word in the learning data such that distributed representations are discriminated between data classes and common features not dependent on data classes are in two areas of “Common segment” and “Individual segment”.

Specifically, for each word, using transformation parameters corresponding respectively to the common features “surface layer, word class and unique representation”, the generator 21 generates distributed representations corresponding respectively to Common segment “surface layer (common), word class (common) and unique representation (common)”, Entity-1 segment “Entity-1 surface layer, Entity-1 word class and Entity-1 unique representation”, Entity-2 segment “Entity-2 surface layer, Entity-2 word class and Entity-2 unique representation”, and Others segment “Others surface layer, Others word classes and Others unique representation” and generates an input vector obtained by combining the respective distributed representations.

In other words, the generator 21 performs morphological analysis, etc., on the learning data to classify the learning data into words or phrases. The generator 21 then determines whether a classified word or phrase corresponds to an entity (Entity 1 or Entity 2). When the word or phrase corresponds to an entity, the generator 21 generates an input vector obtained by inputting the same vector of the same dimension to each of Common segment and Entity segment. Furthermore, when the word or phrase does not correspond to any entity, the generator 21 generates an input vector obtained by inputting the same vector to each of Common segment and Others segment.

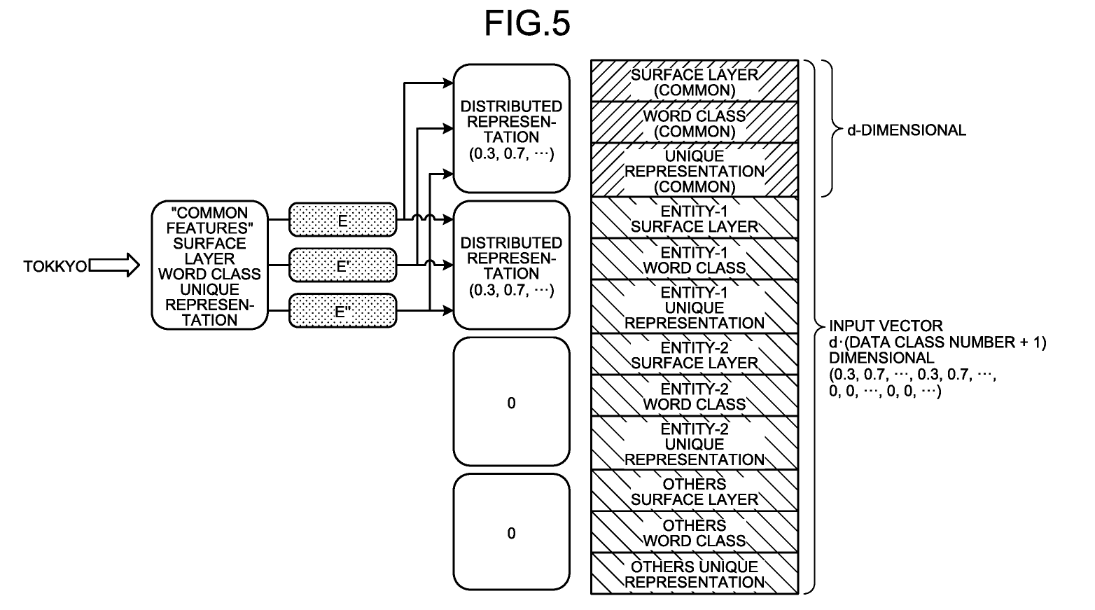

As described above, the generator 21 generates a distributed representation corresponding to a data class to which each word in the learning data belongs and a distributed representation of common features not dependent on data classes to generates an input vector from learning data. In other words, the generator 21 generates an input vector in which a data classes is discriminated by an index. With reference to FIGS. 5 to 7, exemplary generation of an input vector corresponding to each data class will be described.

Data Class: Entity 1

FIG. 5 is a diagram illustrating exemplary generation of an input vector corresponding to Entity 1. As illustrated in FIG. 5, the generator 21 processes the top “Tokkyo” obtained by performing morphological analysis on the learning data of Item 1 using each of Parameter E corresponding to the common feature “surface layer”, Parameter E′ corresponding to the common feature “word class”, and Parameter E″ corresponding to the common feature “unique representation” to generate discrete data “0.3, 0.7, . . . ” corresponding to each of the features.

As “Tokkyo” that is an input corresponds to Entity 1, the generator 21 inputs the generated discrete data “0.3, 0.7, . . . ” corresponding to each of the features to Common segment “surface layer (common), word class (common) and unique representation (common)” to Entity-1 segment “Entity-1 surface layer, Entity-1 word class and Entity-1 unique representation” and inputs 0 to Entity-2 segment and Others segment to generates an input vector “0.3, 0.7, . . . , 0.3, 0.7, . . . , 0, 0, . . . , 0, 0, . . . ”. The generator 21 then inputs the input vector to the learner 22. As each of the features is d-dimensional and there are three data classes (Entity 1, Entity 2, and others) and one common feature, the input vector is “dx4” dimensional data.

Data Class: Others

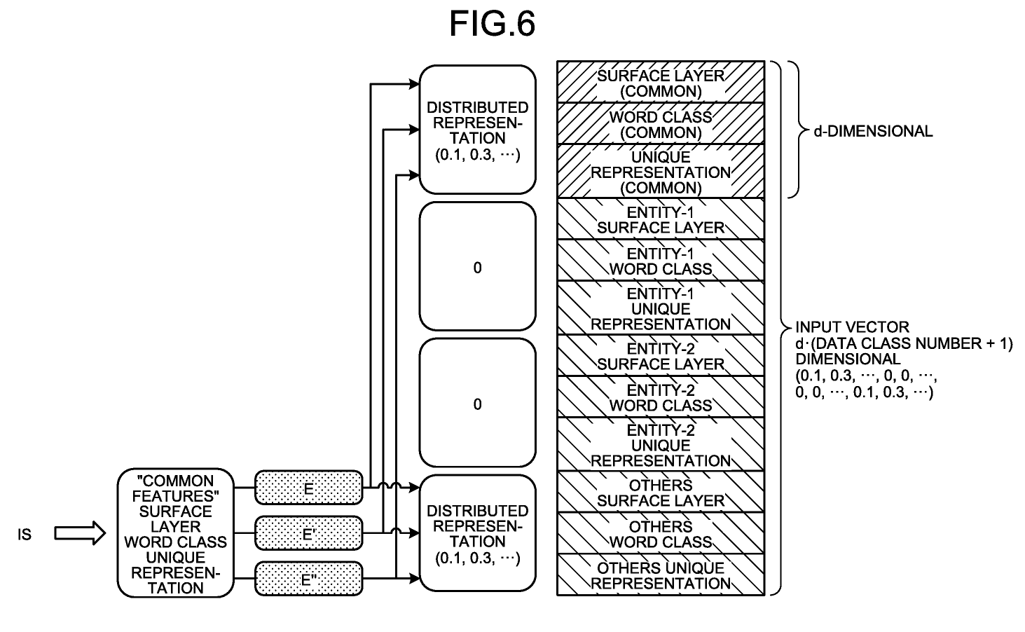

FIG. 6 is a diagram illustrating exemplary generation of an input vector corresponding to others. As illustrated in FIG. 6, the generator 21 processes the top “is” obtained by performing morphological analysis on the learning data of Item 1 using each of Parameter E corresponding to the common feature “surface layer”, Parameter E′ corresponding to the common feature “word class”, and Parameter E″ corresponding to the common feature “unique representation” to generate discrete data “0.1, 0.3, . . . ” corresponding to each of the features.

As “is” that is an input corresponds to Others, the generator 21 inputs the generated discrete data “0.1, 0.3, . . . ” corresponding to each of the features to Common segment “surface layer (common), word class (common) and unique representation (common)”, to Others segment “Others surface layer, Others word class and Others unique representation” and inputs 0 to Entity-1 segment and Entity-2 segment to generate an input vector “0.1, 0.3, . . . , 0, 0, . . . , 0, 0, . . . , 0.1, 0.3, . . . ”. The generator 21 then inputs the input vector to the learner 22.

Data Class: Entity 2

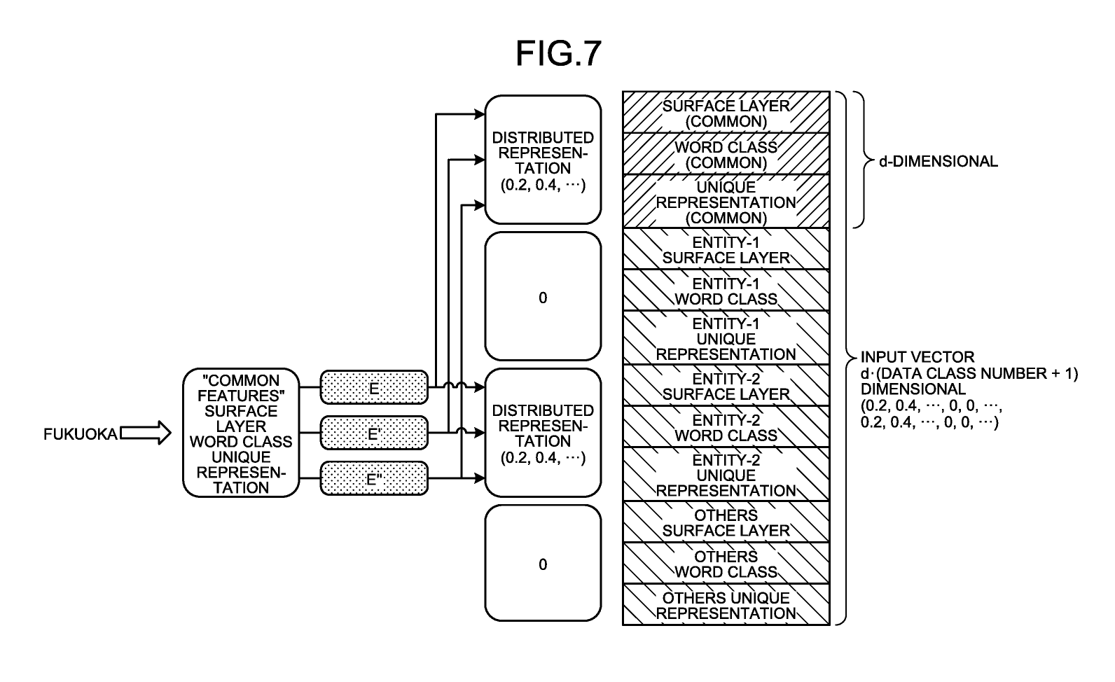

FIG. 7 is a diagram illustrating exemplary generation of an input vector corresponding to Entity 2. As illustrated in FIG. 7, the generator 21 processes the top “Fukuoka” obtained by performing morphological analysis on the learning data of Item 1 using each of Parameter E corresponding to the common feature “surface layer”, Parameter E′ corresponding to the common feature “word class”, and Parameter E″ corresponding to the common feature “unique representation” to generate discrete data “0.2, 0.4, . . . ” corresponding to each of the features.

As “Fukuoka” that is an input corresponds to Entity 2, the generator 21 inputs the generated discrete data “0.2, 0.4, . . . ” corresponding to each of the features to the Common segment “surface layer (common), word class (common) and unique representation (common)” and Entity-2 region “Entity-2 surface layer, Entity-2 word class and Entity-2 unique representation” and inputs 0 to Entity-1 segment and Others Segment to generate and input vector “0.2, 0.4, . . . , 0, 0, . . . , 0, 0, . . . , 0.2, 0.4, . . . ”. The generator 21 then inputs the input vector to the learner 22.

Thereafter, the generator 21 combines the input vectors that are generated for the respective words, etc., of the learning data of Item 1 to generate an input vector corresponding to the learning data and stores the input vector in the teaching data DB 14.

FIG. 2 will be referred back. The learner 22 is a processing unit that inputs the input vectors to the neural network and learns a relationship between the entities. Specifically, the learner 22 inputs the input vectors that are output from the generator 21 to the RNN sequentially to acquire state vectors and inputs the state vectors to an identifying layer to acquire an output value. The learner 22 specifies a correct label corresponding to the input vector from the teaching data DB 14 and, based on an error obtained by comparing the output value and the correction label, learns the RNN. When learning the RNN ends, the learner 22 stores the result of learning in the parameter DB 15. The timing of the end of learning may be set at any time, such as when the error is a given value or smaller or when the number of times of learning is a given number of times or more.

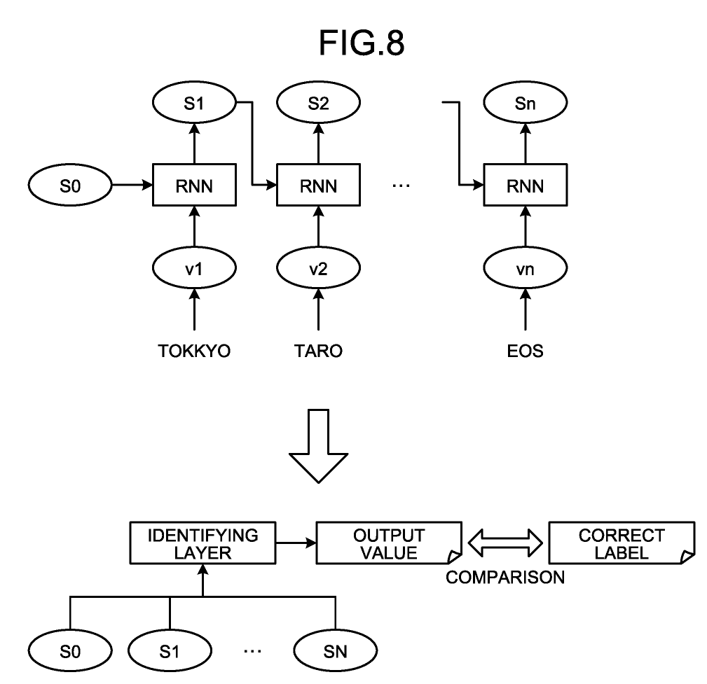

FIG. 8 is a diagram illustrating exemplary learning. As illustrated in FIG. 8, the learner 22 inputs an input vector v1 that is generated from the top word “Tokkyo” of the learning data and an initial value S0 of the state vector to the RNN to acquire a state vector S1. The learner 22 then inputs an input vector v2 that is generated from the second word “Taro” of the learning data and the state vector S1 to the RNN to acquire a state vector S2. In this manner, the learner 22 inputs an input vector that is generated from a word of the learning data and a state vector to the RNN sequentially to generate a state vector and eventually inputs an input vector vn corresponding to EOS representing the end of the learning data to generate a state vector Sn.

The learner 22 then inputs the state vectors (S1 to Sn) that are obtained using the learning data to the identifying layer to acquire an output value. The learner 22 then learns an RNN parameter according to an error back propagation (BP) method using a result of comparison between the output value and the correct label, or the like.

For example, when learning a relationship between “Tokkyo Taro” and “Fukuoka Prefecture” from the learning data “Tokkyo Taro is a Japanese entrepreneur, born in Fukuoka Prefecture, CEO of Fujitsu”, the learner 22 assigns each of the input vectors that are generated from the learning data to the RNN and compares the resultant output value and the correct label “birthplace”. The learner 22 learns the RNN such that the error between the output value and the correct label “birthplace” reduces.

Similarly, when learning a relationship between “Tokkyo Taro” and “Fujitsu” from the learning data “Tokkyo Taro is a Japanese entrepreneur, born in Fukuoka Prefecture, CEO of Fujitsu”, the learner 22 assigns each of the input vectors that are generated from the learning data to the RNN and compares the resultant output value and the correct label “affiliation”. The learner 22 learns the RNN such that the error between the output value and the correct label “affiliation” reduces.

The case where all the state vectors (S1 to Sn) are used has been described; however, embodiments are not limited thereto and any combination of state vectors may be used. Furthermore, exemplary learning using the RNN has been described; however, embodiments are not limited thereto, and other neural networks, such as a convolutional neural network (CNN) may be used.

Flow of Processes

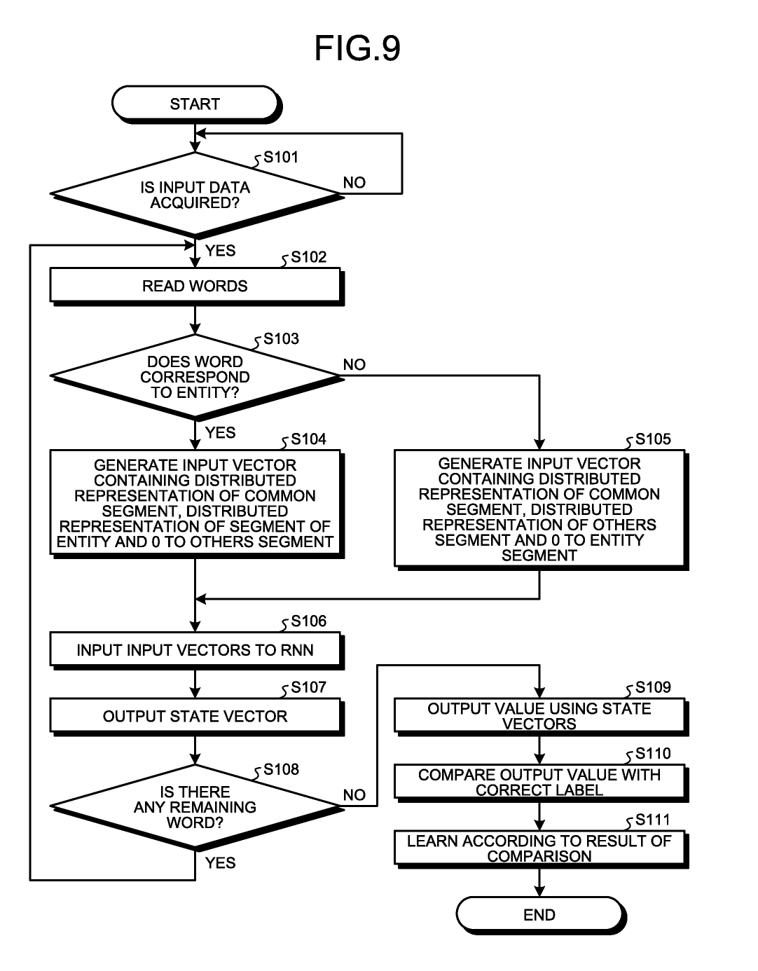

FIG. 9 is a flowchart illustrating a flow of processes. As illustrated in FIG. 9, when the generator 21 of the learning device 10 acquires learning data (S101: YES), the generator 21 performs morphological analysis on the learning data to acquire multiple words and reads the words sequentially from the top (S102).

When a read word corresponds to an entity (S103: YES), the generator 21 generates an input vector obtained by generating a distributed representation of a common segment and a distributed representation of a segment of the entity and inputting 0 to others (a segment of a not-corresponding entity and another segment) (S104).

On the other hand, when the read word does not correspond to any entity (S103: NO), the generator 21 generates an input vector obtained by generating a distributed representation of a common segment and a distributed representation of others segment and inputting 0 to each entity segment (S105).

The generator 21 then inputs the generated input vectors to the RNN (S106) and the learner 22 uses the input vectors to output a state vector (S107). When an unprocessed word remains (S108: YES), S102 and the following steps are repeated.

On the other hand, when no unprocessed word remains (S108: NO), the learner 22 inputs the state vectors that are output using the input vectors corresponding to the respective words to the identifying layer to output a value (S109).

The learner 22 compares the output value that is output from the identifying layer and a correct label (S110) and, according to the result of the comparison, learns various parameters of the RNN (S111).

Effect

As described above, the learning device 10 clearly discriminates “data classes”, which are task-dependent and thus are learned less progressively, in input representations, thereby enabling omission of learning for identifying the data classes. Clearly discriminating differences among data classes in input representations causes an adverse effect of less progressive acquisition of characteristics not dependent on data classes; however, sharing part of an input representation among all the data classes makes it possible to eliminate the adverse effect. Accordingly, the learning device 10 does not acquire characteristics representing discrimination among data classes by learning and accordingly is able to reduce needed data and learning costs and learn from a small amount of learning data.

Furthermore, discriminating an index according to a data class may cause less-progressive learning of characteristics not dependent on data classes among features of subject words of the data class; however, the learning device 10 shares a common feature among multiple data classes using the same index and inputs the index to the neural network for learning. Accordingly, the learning device 10 enables the neural network to learn the characteristic not dependent on data classes and the characteristic dependent on data classes simultaneously and thus inhibit occurrence of the above-described adverse effect.

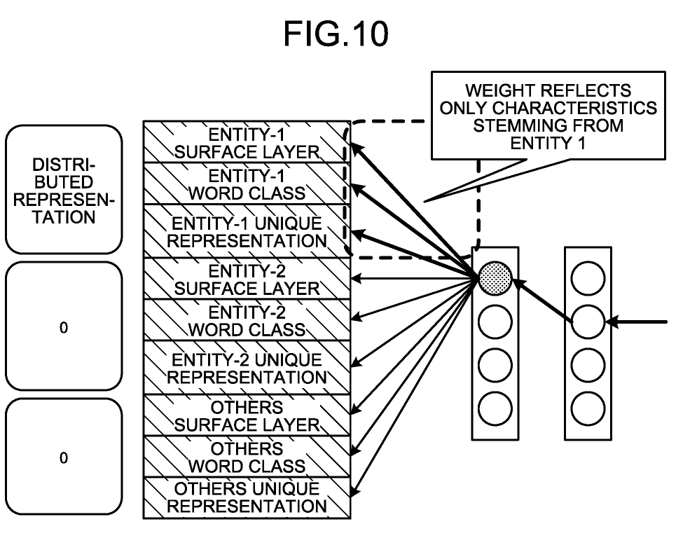

FIG. 10 is a diagram illustrating an effect of learning using a distributed representation of each data class. In learning by the learning device 10, each of weight parameters of a neural-net first layer stems from only single type of data class. For example, as illustrated in FIG. 10, when an input vector of a word corresponding to Entity 1 is input, the weight reflects only characteristics stemming from Entity 1. Accordingly, the data class is clearly discriminated in the input vector and thus the learning device 10 is able to omit execution of the process of “discriminating the data class in the neural net”. Thus, the learning device 10 is able to reduce resources for identifying data classes, such as the amount of learning data or neural-net layers.

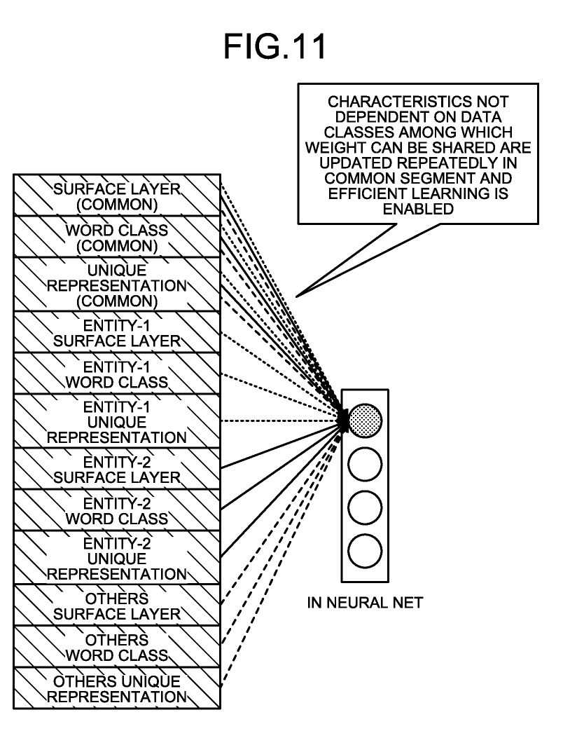

FIG. 11 is a diagram illustrating an effect of learning using a distributed representation of common features not dependent on data classes. Using only distributed representations of respective data classes leads to less-progressive learning of characteristics not dependent on data classes. To deal with this, as illustrated in FIG. 11, in the learning device 10, a common segment not dependent on data classes is provided so that a weight from the common segment is shared, and accordingly the frequency of update increases and thus effective learning is enabled. In other words, the characteristics not dependent on data classes among which the weight can be shared are updated repeatedly in the common segment and thus efficient learning is enabled.

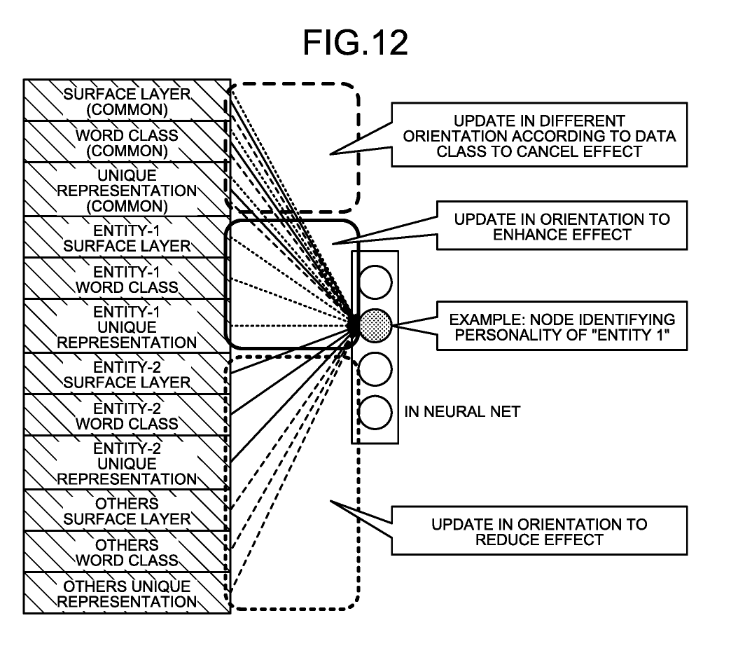

FIG. 12 is a diagram illustrating an effect of learning according to the first embodiment. By combining FIG. 10 and FIG. 11, the learning device 10 according to the first embodiment is able to increase learning efficiency. For example, a node that identifies the personality of the person of Entity 1 will be exemplified here. As illustrated in FIG. 12, for the common segment, an update in a different orientation according to the data class is made and the effect is canceled, for Entity-1 segment, an update in an orientation to enhance the effect is made and, for Entity-2 segment and Others segment, an update in an orientation to reduce the effect is made.

As described above, as for the characteristics dependent on data classes, the orientation of the effect of propagation of error to the common region differs according to the data class and thus the learning device 10 is able to cancel the effect. Accordingly, the learning device 10 is able to increase the learning efficiency and thus is able to learn efficiently using less amount of learning data.

### Second Embodiment

The first embodiment of the present invention has been described; however, the present invention may be carried out in various different modes in addition to the above-described first embodiment.

Learning Data

The first embodiment illustrates the example where one sentence consisting of multiple words is used as learning data; however, embodiments are not limited thereto and at least one word may be used as learning data. In other words, one or more word feature series may be used. A learning method of not inputting input vectors that are generated from respective words of learning data of one sentence to an RNN sequentially but inputting one set of input data obtained by combining input vectors that are generated from respective words of learning data of one sentence to a neural network may be employed.

Common Feature

In the first embodiment, “surface layer, word class and unique representation” are exemplified as features; however, features are not limited thereto. The type and number of features may be changed optionally. The parameter E, etc., are known information that is determined in advance. For example, even for word class, Parameter E1′ is associated with noun and Parameter E2′ is associated with particle. Similarly, even for unique representation, Parameter E1″ is associated with person and Parameter E2″ is associated with land.

Neural Network

The first embodiment illustrates the example where an RNN is used. Alternatively, another neural network, such as a CNN, may be sued. As for the learning method, known various methods may be employed other than backpropagation. The neural network has, for example, a multilayer structure consisting of an input layer, an intermediate layer (hiding layer) and an output layer. Each of the layers has a structure where nodes are connected via edges. Each of the layers has a function referred to as “activation function”, an edge has a “weight”, and the value of each node is calculated from the value of the node of the previous layer, the value of the weight of the connecting edge, and the activation function of the layer. Various known methods may be employed for the calculating method.

System

The process procedure, control procedure, specific names, and information containing various types of data and parameters that are represented in the above descriptions and the accompanying drawings may be changed optionally unless otherwise noted.

Each component of each device illustrated in the drawings is a functional idea and does not always physically configured as illustrated in the drawings. In other words, specific modes of distribution or integration in each device is not limited to those illustrated in the drawings and all or part of the components may be distributed or integrated functionally or physically according to a given unit in accordance with various types of load and usage. Furthermore, all or any part of the processing functions that are implemented in the respective devices may be implemented by a CPU and a program that is analyzed and executed by the CPU or may be implemented as hardware using a wired logic.

Hardware Configuration

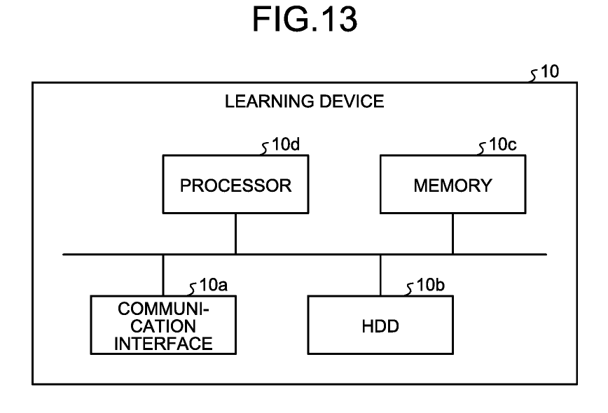

FIG. 13 is a diagram illustrating an exemplary hardware configuration. As illustrated in FIG. 13, the learning device 10 includes a communication interface 10a, a hard disk drive (HDD) 10b, a memory 10c and a processor 10d. The determination device 50 has a similar configuration.

The communication interface 10a is a network interface card that controls communication with other devices. The HDD 10b is an exemplary storage device that stores a program and data.

Examples of the memory 10c include a random access memory (RAM) such as a synchronous dynamic random access memory (SDRAM), a read only memory (ROM), or a flash memory. Examples of the processor 10d include a central processing unit (CPU), a digital signal processor (DSP), a field programmable gate array (FPGA), and a programmable logic device (PLD).

The learning device 10 operates as an information processing device that reads and executes the program to execute the learning method. In other words, the learning device 10 executes a program to implement the same functions as those of the generator 21 and the learner 22. As a result, the learning device 10 is able to execute processes to implement the same functions as those of the generator 21 and the learner 22. Programs according to other embodiments are not limited to those executed by the learning device 10. For example, the present invention is applicable to a case where another computer or another server executes the program or a case where another computer and another server cooperate to execute the program.

According to the embodiments, it is possible to implement efficient learning using less learning data.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A learning method comprising:
generating an input vector obtained by loading a distributed representation of each of words or phrases included in subject data into a common dimension and a dimension corresponding to a data class representing a role in the subject data, using a processor; and
executing machine learning that uses the input vectors and that relates to features of the words or phrases included in the subject data, using the processor.

2. The learning method according to claim 1, wherein
the generating includes sequentially generating the input vectors of the words or phrases that appear in the subject data according to an order in which the words or the phrases appear and sequentially inputting the input vectors into a recurrent neural network; and
the executing includes, using each of state vectors that are output values from the recurrent neural network to which each of the input vectors is input, executing the machine learning relating to the features of the words or phrases included in the subject data.

3. The learning method according to claim 1, wherein
the generating includes generating a connected input vector using the input vector that is generated for each of the words or phrases included in the subject data and inputting the connected input vector into the neural network, and
the executing includes executing machine learning relating to the features of the words or phrases contained in the subject data.

4. The learning method according to claim 1, wherein
the generating includes, using transformation parameters corresponding respectively to surface layer, word class and unique representation that are common features between the words or phrases, generating a distributed representation corresponding to the common dimension and a distributed representation corresponding to the data class from the words or phrases to generate the input vector obtained by connecting the distributed representations.

5. The learning method according to claim 4, wherein
the generating includes, when the word or phrase corresponds to an entity whose relationship is to be learned, setting, among a first distributed representation of the common dimension, a second distributed representation of a data class corresponding to the entity, and a third representation of others excluding the entity, the third distributed representation at 0 and generating the input vector obtained by connecting the first distributed representation, the second distributed representation and the third distributed representation and, when the word or phrase does not correspond to the entity, setting the second distributed representation at 0 and generating the input vector obtained by connecting the first distributed representation, the second distributed representation and the third distributed representation.

6. A method of using a result of learning comprising:
using a learned model obtained by inputting an input vector obtained by loading a distributed representation of each of words or phrases included in subject data into a common dimension and a dimension corresponding to a data class representing a role in the subject data and by executing learning that relates to features of the words or phrases included in the subject data, using a processor; and
acquiring a result of determination from the input vector obtained by loading a distributed representation of each of words or phrases included in determination subject data into a common dimension corresponding to the input vector used to learn the learning model and a dimension corresponding to the data class, using the processor.

7. A non-transitory computer-readable recording medium having stored therein a program that causes a computer to execute as a learned model comprising:
inputting an input vector obtained by loading a distributed representation of each of words or phrases contained in determination subject data into a common dimension and a dimension corresponding to a data class representing a role in the determination subject data; and
outputting a value representing a relationship between specified data classes.

8. A non-transitory computer-readable recording medium having stored therein a data structure that includes an input vector obtained by loading a distributed representation of each of words or phrases contained in subject data into a common dimension and a dimension corresponding to a data class representing a role in the subject data and a relationship label value representing a relationship between specified data classes and that is used by a learning device to learn a relationship between the input vector and the relationship label value.

9. A generating method comprising:
generating an input vector obtained by loading a distributed representation of each of words or phrases included in subject data into a common dimension and a dimension corresponding to a data class representing a role in the subject data, using a processor; and
generating data in which the input vector and a relationship label value representing a relationship between specified data classes are associated with each other, using the processor.

10. A non-transitory computer-readable recording medium having stored therein a program that causes a computer to execute a process comprising:
generating an input vector obtained by loading a distributed representation of each of words or phrases included in subject data into a common dimension and a dimension corresponding to a data class representing a role in the subject data; and
executing machine learning that uses the input vectors and that relates to features of the words or phrases included in the subject data.

11. A learning device comprising:
a processor configured to:
generate an input vector obtained by loading a distributed representation of each of words or phrases included in subject data into a common dimension and a dimension corresponding to a data class representing a role in the subject data; and
execute machine learning that uses the input vectors and that relates to features of the words or phrases included in the subject data.
